(19) United States
(12) Patent Application Publication
(10) Pub. No.: US 2013/0274153 A1
(43) Pub. Date: Oct. 17, 2013

(54) ALKALI-ACTIVATED COATINGS FOR PROPPANTS

(71) Applicant: Thomas Urbanek, Calgary (CA)

(72) Inventor: Thomas Urbanek, Calgary (CA)

(73) Assignee: GEOPROPPANTS INC., Chestermere, AB (CA)

(21) Appl. No.: 13/882,276

(22) PCT Filed: Oct. 28, 2011
(86) PCT No.: PCT/CA2011/001198

§ 371 Date: Jul. 8, 2013

Related U.S. Application Data
(60) Provisional application No. 61/407,666, filed on Oct. 28, 2010.

(51) Int. Cl. C09K 8/80

(52) U.S. Cl. CPC C09K 8/805
USPC 507/214; 507/219; 507/269; 507/244; 507/270; 507/274

(57) ABSTRACT

The present invention relates to proppants and the manufacture of proppants by contacting a substrate with an alkali-activated composition that cures to form a continuous polymer coating.

### FIELD OF INVENTION

The present invention relates to proppants and the manufacture of proppants by contacting a substrate with an alkali-activated composition that cures to form a coating.

### BACKGROUND OF THE INVENTION

Hydraulic fracturing is a process involving the injection of fluids into an oil or gas bearing formation at sufficiently high pressures and rates that the formation fails in tension, and fractures are formed. In order to keep the fractures permeable once the pressure is released, a propping agent, commonly referred to as ‘proppant’, is mixed with the fluids and injected into the fractures.

Proppants are characterized by properties such as their specific gravity, crush strength, hardness, thermal stability, surface smoothness, corrosion resistance, and their particle size, shape and distribution.

Silica sand, commonly referred to as ‘frac-sand’, is the most prevalent proppant even though its use is limited to shallow formations. Ceramic proppants were originally developed for use in deep wells, where the crush strength of sand is inadequate. Later on, manufacturers introduced ceramic proppants for wells of intermediate depths to expand their addressable market. The third-most common type of proppants is resin-coated sand.

A variety of references disclose proppants coated with organic polymers, commonly referred to as resins, that are partially cured, applied in-situ, cured at elevated temperatures, are dissolvable, applied in layers or as a mixture of thermosets and thermoplastics. The coatings, for instance, serve the purpose to reduce the flow-back of proppants to the wellhead, the erosion by acids and to improve the sphericity, roundness and crush strength of particular substrates.

Conversely, the literature describing inorganic materials as coatings for proppants or their precursors is very limited. U.S. Pat. No. 7,491,444 to Smith et al. claims the use of alumoxane and mullite coatings, both having a sintering temperatures above 700° C., as materials to repair cracks and flaws of a template sphere during the manufacture of a proppant.

There is a need for a durable inorganic proppant coating whose ultimate properties develop at lower than sintering temperatures. The present invention seeks to address the perceived limitations in the art by providing a novel coating material to manufacture a proppant.

### SUMMARY OF THE INVENTION

The present invention relates to proppants and the manufacture of proppants by contacting a substrate with an alkali-activated composition that cures to form a coating.

According to an embodiment of the present invention, there is provided an alkali-activated coating composition to manufacture a proppant. In a preferred embodiment, an aqueous composition comprising one or more aluminosilicates is applied to the surface of a particulate substrate and cured at temperatures between 20 and 500° C. to form an inorganic coating. The cured coating enhances the physical attributes of the particulate substrate and its utility as a proppant in the production of oil and gas.

In certain embodiments, the proppant may comprise a particulate substrate and one or more layers of a coating around the surface of the particulate substrate. The coating, excluding the composition of fillers and other auxiliary components, may comprise an alkali-activated binder with a molar ratio of SiO₂/Al₂O₃ ranging from 1 to 20. In addition, or alternatively, the coating may react and cure at temperatures between 20° C. and 500° C. to form an inorganic polymer.

In further non-limiting embodiments, the proppant described herein may have one or more of the following features:
i. the coating may comprise an aluminosilicate;
ii. the cured coating may comprise a geopolymer;
iii. the binder may comprise one or more fluoride complexes with a molar ratio F⁻/SiO₂ranging from 0 to 1;
iv. the coating may comprise one or more additives, such as fillers, plasticizers, pore or void formers, hollow spheres, reinforcing materials, cure accelerators or retarders, solvents, surfactants, pigments and rheology modifiers, etc.;
v. the coating may comprise one or more organic polymers;
vi. the coating may comprise a complex fluorosilicate;
vii. the coating may cure under polycondensation;
viii. the coating may have a dry film thickness of 0.5 to 250 microns;
ix. the coating and curing steps may be repeated;
x. the composition of the coating may vary between coats;
xi. the first coating layer may function as a primer;
xii. at least a portion of the coating may impregnate the particulate substrate;
xiii. a portion of the coating may physically bond with the particulate substrate;
xiv. a portion of the coating may chemically bond with one or more components comprising the particulate substrate;
xv. the coating may comprise a material including fillers, additives, or both fillers and additives;
xvi. the coating may contain at least one reinforcing agent, such as a fiber;
xvii. the coating may comprise a solvent;
xviii. the coating may be a sol-gel;
xix. at least one component comprising the coating may be dissolved in the solvent;
xx. at least one component comprising the coating may be dispersed in the solvent;

xxi. the solvent may be water;
xxii. the coating may comprise a content of solids between 20 and 85 percent by weight;
xxiii. at least one layer of the cured coating may be substantially non-porous;
xxiv. at least one layer of the cured coating may be substantially porous;
xxv. the pores of the coating may be microporous or mesoporous, or both;
xxvi. the particulate substrate may be a naturally occurring or man-made material, such as a mineral, ceramic, ceramic precursor or ceramic oxide, a metal oxide, a glass, a polymer, a waste product, or a composition thereof;
xxvii. the particulate substrate may comprise alumina, an aluminumsilicate, a silicate, or metal phosphate;
xxviii. the particulate substrate may comprise sand or a geopolymer;
xxix. the coating may encapsulate temporary components that the particulate substrate may comprise;
xxx. the coating may improve the crush strength of the particulate substrate;
xxxi. the coating may improve the acid resistance of the particulate substrate;
xxxii. the coating may improve the abrasion resistance of the particulate substrate;
xxxiii. the coating may improve the sphericity or roundness, or both, of the particulate substrate;
xxxiv. the coating may bind a larger-sized filler to the surface of the substrate, giving the proppant a dimpled surface;
xxxv. the particulate substrate may be porous;
xxxvi. the coating may reduce the porosity of the particulate substrate;
xxxvii. the particulate substrate may be hollow;
xxxviii. the manufacturing method may further comprise a step of coating the proppant with an organic polymer coating; and/or
xxxix. the coated proppant may be useful to the production of oil and gas.

This summary of the invention does not necessarily describe all features of the invention.

### DETAILED DESCRIPTION

The following is a description of a preferred embodiment.

It is well known in the art that organic polymer coatings are useful to modify the properties of proppants. Coated proppants, for instance, provide improved fracture permeabilities, extend depth ranges, encapsulate fines formed under compression, and reduce the flow-back of proppants to the wellhead. Conversely, the literature describing inorganic coating materials for proppants or their precursors is very limited.

In an embodiment, the present invention utilizes an alkali-activated composition as a material to coat a substrate and form a proppant. In a further embodiment, the composition comprises an alkali-activated aluminosilicate binder, and more specifically a geopolymer.

Purdon conducted significant work on alkali-activated binders in the 1940s. A decade later, Glukhovsky proposed a reaction mechanism for binders primarily comprising silica and alumina. The mechanism distinguished three reaction phases: destruction, coagulation, and crystallization. More recently, several authors elaborated on the proposed mechanism. Particular attention was given to a subset of alkali-activated materials that Davidovits coined ‘geopolymers’. Geopolymers are a group of aluminosilicates that form at low temperatures via the polycondensation of aluminate and silicate monomers. Due to their inorganic nature, geopolymers encompass high compressive strengths and high thermal and chemical stabilities. Geopolymers are found in diverse products, such as fire-retardant and rustproof coatings, tiles, heat-resistant components, filters, sculptures, paving materials, and encapsulants. U.S. Pat. No. 7,160,844 to Urbanek also discloses the use of geopolymers to manufacture a proppant.

U.S. Patent Application Publication No. 2009/0100766 to Gebhardt discloses the composition of a highly diluted aluminosilicate binder comprising a fluoride complex. The binder is used as an adhesive to bond a finely divided inorganic powder to abrasive grains. The adhered powder increases the surface texture of the grains and, in turn, improves bonding of the grains to flexible or rigid supports. The binder is cured at temperatures below 400° C. The content of solids is kept at about 40 percent by weight.

U.S. Patent Application 20100304165 to Han et al. discloses the composition of latex-modified geopolymers and the use of the material as a coating.

European patent application EP 0 485 966 A2 to Elbel discloses the composition of geopolymers comprising a finely divided organic polymer, and the manufacture of a bonded abrasive therefrom.

The present invention utilizes at least one source of silicate and aluminate monomers and alkalis to compose an alkali-activated binder.

Suitable sources of aluminosilicates include fly ashes, silica, activated silica, aluminum oxide, slags, hydrous and anhydrous aluminosilicates, calcined kaolin, kaolinite, and mixtures thereof. The materials are used in their reactive, finely divided forms and may be readily available as waste products of industrial processes. Excluding the composition of fillers and auxiliary components, the cured alkali-activated binder preferably comprises Al₂O₃ between 0.1 and 25 weight percent and SiO₂ between 2 and 43 weight percent, or molar ratios of SiO₂/Al₂O₃ ranging from 1 to 20 and SiO₂/H₂O ranging from 0.001 to 8.

The overall concentration of solids is kept between 20 and 85 weight percent, and more preferably between 35 and 70 weight percent.

Sources of alkali may comprise alkali hydroxides, alkali silicates, alkali aluminates, alkali silicon fluorides or mixtures thereof The alkalis may comprise lithium, sodium or potassium and mixtures thereof.

The composition may also comprise one or more alkali fluoride complexes. Fluoride complexes may be selected from alkali aluminum fluorides, alkali silicon fluorides, alkali boron fluorides, or from mixed complexes. The alkalis may comprise lithium, sodium or potassium and mixtures thereof. Excluding the composition of fillers and auxiliary components, the cured alkali-activated binder preferably comprises F⁻ between 0.1 and 25 weight percent, or molar ratios F⁻/SiO₂ ranging from 0 to 1.

In one or more embodiments, inorganic coatings of this invention may comprise additives and auxiliary components, such as fillers, fibers, plasticizers, cure accelerators and retarders, pore or void formers, hollow spheres, reinforcing materials, fluxes, solvents, surfactants, coupling agents, pigments, polymers and rheology modifiers. They may be used to modify the economical, physical, and chemical properties of the disclosed compositions.

Compatible fillers may include waste materials such as fly ash, sludges, slags, waste paper, rice husks, saw dust, etc., volcanic aggregates, such as expanded perlite, pumice, scoria, obsidian, etc., minerals, such as diatomaceous earth, mica, wollastonite, borosilicates, clays, metal oxides, etc., plant and animal remains, such as sea shells, coral, hemp fibers, etc., manufactured fillers, such as silica, mineral and carbon fibers and fiberglass. The concentration of fillers may reach up to 70 percent by weight.

Coatings of this invention may also comprise one or more organic polymers, such as natural rubber, polyethylene, polypropylene, polybutadiene, polystyrene, polycarbonates, polyesters, polyacrylates, polymethacrylates and their copolymers or mixtures. The polymers may be introduced as a solution, dispersion or in their finely divided form.

Particulate substrates may be natural or man-made materials, including those that can be used as proppants without the application of the disclosed coating. Thus, the substrate may be sand, or a geopolymer or ceramic particle suitable for hydraulic fracturing. The substrate may substantially comprise an inorganic material, such as a mineral, ceramic or glass that may be chemically classified as an oxide, carbonate, sulfate, silicate, aluminate, borate, ferrate or phosphate, or alternatively an organic material, such as a polystyrene, polybutadiene, polyethylene, polypropylene, polyurethane, polyacrylate, cellulose or protein, or comprise a mixture or composite thereof. Substrates may further comprise auxiliary components, such as binders, fillers, reinforcing materials, foams, hollow spheres, nanoparticles and others.

Particulate substrates may be solid, comprise a void or a multitude of mostly open or closed pores or voids. The pores and voids may be substantially similar or dissimilar in size. Substrates may also comprise two or more adjoining particles. Substrates comprising more than three adjoining particles may comprise interstitial voids.

The coating of the present invention may be applied in one or more layers using conventional devices and processes, such as fluidized beds, pug mills, paddle mixers and be sprayed or dipped. The composition and properties of the coating may vary between layers and serve different functions. The first layer, for instance, may assist bonding of a subsequent layer to the particulate substrate and be generally considered a primer.

Curing of the coating is accomplished at temperatures between 20 to 500.degree. C. The curing step may be done statically, but rotary kilns are the preferred apparatus for this step. The residence time of coated particles in the kiln depends upon several parameters: the kiln length, diameter, rotational speed, feed rate to the kiln, temperature within the kiln and the curing characteristics of the coating. The residence time may be adjusted to achieve sufficient curing for storage stability, but also to reach ultimate coating properties. Typical residence times in the kiln correspond to 5 minutes or more.

The coating may be substantially uniform in film thickness around the surface of a particulate substrate and have a cured film thickness of any amount. Film thicknesses between 0.5 and 250 microns, however, are preferred.

Bonding of the coating to a particulate substrate may be physical in nature, but also through chemical bonds with one or more components comprising the substrate. Chemical bonds may be ionic, covalent, or both. As part of the interaction with the substrate, portions of the coating may also diffuse, infiltrate or impregnate a portion of the substrate and develop physical or chemical bonds, or both.

In one or more embodiments, the surface of the coating may also be modified through the embedment of a larger-sized filler, which provides the proppant with a dimpled surface.

In one or more embodiments, the surface of the proppant may be modified through the application of one or more organic materials, such as a surfactant, to change the surface of the proppant, for instance, from being hydrophobic to hydrophilic. Surface modifications may further include substances that, upon activation, effectively yield changes in the fracturing fluid, such as changing the fluid's rheology through gel breakers. Organic polymer coatings may also be used to modify the properties of the proppant. They may comprise, for instance, epoxies, polyurethanes, phenols, ureas, melamine formaldehyde, furans, synthetic rubber, natural rubber, polyester resin, their copolymers and blends. The modifiers may be absorbed by or bonded or adsorbed to the surface of the proppant.

The present invention provides an inorganic coating that cures at lower temperatures than those required for the materials disclosed in U.S. Pat. No. 7,491,444. This is highly beneficial as it allows the coating of heat-sensitive materials, such as organic or porous matter, without causing undesirable physical or chemical changes.

Lower cure temperatures may also reduce the stress between substrate and coating that typically develops during the cooling phase. This may improve the adhesion of the coating. Finally, lower cure temperatures equate with lower energy requirements to manufacture proppants.

As described above, particulate matter preferably meets a number of chemical and physical criteria to find utility as a proppant. In cases where the properties of a particulate matter are deficient in one or more aspects, improvements may be achieved by applying the disclosed inorganic coating. In one or more embodiments, and as exemplified by U.S. Pat. No. 7,491,444 with alternate materials, coatings of this invention may be used to improve the roundness and sphericity of a substrate and to significantly improve its compressive strength. Thus, substandard particles may meet the specifications once the disclosed coating is applied. The provided compositions may also be used to seal open pores of porous substrates. This may improve the buoyancy of the proppant during fracturing and the acid and abrasion resistance of substrates. Furthermore, particulate substrates may contain components that need to be contained or protected. This, for instance, may be a water-soluble metal compound contained in a natural or man-made raw material or particulate substrate. In one or more embodiments, the disclosed coating may be used to encapsulate such components.

While the term proppant has been used to identify the preferred use of the materials of the present invention, it is to be understood that the materials of the present invention can be used in other applications, such as medical and pharmaceutical applications, filtration, as a filler and support for catalysts, and the like.

The present invention will be further clarified by the following examples, which are intended to be exemplary of the present invention.

### EXAMPLE 1

Hollow spheres (Omya Fillite) with a mean particles size of 0.15 mm were coated with a composition comprising molar ratios SiO₂/Al₂O₃=3, SiO₂/H₂O=0.08, F⁻/SiO₂=0.5. Thus, 0.3 kg spheres, 15 g calcined kaolin (Imerys), 12 g silica flour (Sil Industrial Minerals), 3 g of sodium hexafluorosilicate and a mixture of 24 g of water and 36 g of a 38 percent solution of sodium silicate (Kasil N) were blended in an intensive mixer. The blend was then transferred to a rotating pelletizer. In one example, the coated particles were dried for 1 hour at 100° C., and cured for 20 minutes at 375° C. The coating adhered well to the spheres.

### EXAMPLE 2

Geopolymer particles with a mean particles size of 0.3 mm were coated with a composition comprising molar ratios SiO₂/Al₂O₃=3.2, SiO₂/H₂O=0.08, F⁻/SiO₂=0.8. Thus, 1 kg geopolymer particles, 15 g calcined kaolin (Imerys), 12 g silica flour (Sil Industrial Minerals), 5 g of sodium hexafluorosilicate and a mixture of 24 g of water and 40 g of a 38 percent solution of sodium silicate (Kasil N) were blended in an intensive mixer. The blend was then transferred to a rotating pelletizer. In one example, the coated geopolymer particles were dried for 1 hour at 100° C. and cured for 20 minutes at 375° C. The coating was well adhered and improved the sphericity and roundness from 0.7 to 0.9, respectively.

All citations are hereby incorporated by reference.

The present invention has been described with regard to one or more embodiments. However, it will be apparent to persons skilled in the art that a number of variations and modifications can be made without departing from the scope of the invention as defined in the claims.

1. A proppant comprising a particulate substrate and one or more layers of a coating around the surface of the particulate substrate, wherein the coating, excluding the composition of fillers and other auxiliary components, comprises an alkali-activated binder with a molar ratio of SiO₂/Al₂O₃ ranging from 1 to 20.

2. A proppant comprising a particulate substrate and one or more layers of a coating around the surface of the particulate substrate that reacts and cures at temperatures between 20° C. and 500° C., and forms an inorganic polymer.

3. The proppant of claim 1, wherein the coating or the binder comprises an aluminosilicate.

4. The proppant of claim 1, wherein the cured coating or the binder comprises a geopolymer.

5. The proppant of claim 1, wherein the binder comprises one or more fluoride complexes with a molar ratio of F⁻/SiO₂ranging from 0 to 1.

6. The proppant of claim 2, wherein the coating comprises a complex fluorosilicate.

7. The proppant of claim 1, wherein the binder reacts and cures at temperatures between 20° C. and 500° C.

8. The proppant of claim 2, wherein the coating cures under polycondensation.

9. The proppant of claim 1, wherein the coating comprises one or more fillers, plasticizers, pore or void formers, hollow spheres, reinforcing materials, cure accelerators or retarders, solvents, surfactants, pigments, or rheology modifiers.

10. The proppant of claim 1, wherein the coating comprises one or more organic polymers.

11. The proppant of claim 1, wherein the coating has a dry film thickness of 0.5 to 250 microns.

12. The proppant of claim 1, wherein the steps of applying and curing the coating are repeated.

13. The proppant of claim 1, wherein the composition of the coating varies between coats.

14. The proppant of claim 1, wherein the first coating layer functions as a primer.

15. The proppant of claim 1, wherein the composition of the coating varies between coats.

16. The proppant of claim 1, wherein the first coating layer functions as a primer.

17. The proppant of claim 1, wherein at least one layer of the cured coating is substantially non-porous.

18. The proppant of claim 1, wherein at least one layer of the cured coating is substantially porous.

19. The proppant of claim 18, wherein pores of the coating are microporous or mesoporous, or both.

20. The proppant of claim 1, wherein the particulate substrate is a naturally occurring or man-made material selected from the group consisting of minerals, ceramics, ceramic precursors, ceramic oxides, metals or semimetal oxides, glass, polymers, cellulose, protein, waste products or combinations thereof

21. The proppant of claim 1, wherein the particulate substrate comprises alumina, an aluminosilicate, a silicate or phosphate.

22. The proppant of claim 1, wherein the particulate substrate comprises sand or a geopolymer.

23. The proppant of claim 1, wherein the coating encapsulates components that the particulate substrate comprises.

24. The proppant of claim 1, wherein the coating improves the crush strength of the particulate substrate.

25. The proppant of claim 1, wherein the coating improves the acid resistance of the particulate substrate.

26. The proppant of claim 1, wherein the coating improves the abrasion resistance of the particulate substrate.

27. The proppant of claim 1, wherein the coating improves the sphericity or roundness of the particulate substrate, or both.

28. The proppant of claim 1, wherein the coating binds a larger-sized filler to the surface of the substrate, which gives the proppant a dimpled surface.

29. The proppant of claim 1, wherein the particulate substrate is porous.

30. The proppant of claim 1, wherein the coating reduces the open porosity of the particulate substrate.

31. The proppant of claim 1, wherein the particulate substrate comprises a hollow sphere.

32. The proppant of claim 1, wherein one or more organic polymers are applied to the proppant.

33. The proppant of claim 1, whereby the proppant is useful to the production of oil and gas.
